(19) United States
(12) Patent Application Publication
(10) Pub. No.: US 2008/0037950 A1
(43) Pub. Date: Feb. 14, 2008

(54) VIDEO RECORDING/REPRODUCING APPARATUS

(76) Inventors: Toshihiko Ono, Yokohama (JP); Mikito Komatsu, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/675,192

(22) Filed: Feb. 15, 2007

(30) Foreign Application Priority Data
Aug. 10, 2006 (JP) 2006-217720

(51) Int. Cl. H04N 5/91

(52) U.S. Cl. 386/68

(57) ABSTRACT

When a fast forward button is depressed in a highlight reproduction mode, the highlight reproduction mode is released in a conventional way. Therefore, if the next key (highlight) scene is desired to be reproduced and viewed, it has been necessary to set again the highlight reproduction mode by operating buttons of a remote controller or the like, resulting in a problem of difficult-to-use. In a video recording/reproducing apparatus equipped with a highlight reproduction function of reproducing key scenes of a program stored in a storage medium, after operation of a predetermined function during the operation of the highlight reproduction function, if the predetermined function is released, the operation returns to the operation of the highlight reproduction function.

### INCORPORATION BY REFERENCE

The present application claims priority from Japanese application JP2006-217720 filed on Aug. 10, 2006, the content of which is hereby incorporated by reference into this application.

### BACKGROUND OF THE INVENTION

1. Field of the Invention

The present invention relates to a video recording/reproducing apparatus and more particularly to improvement on using the apparatus for viewing a program by highlight reproduction.

2. Description of the Related Art

As a function of viewing a recorded program in a short time, a video recording/reproducing apparatus is provided with a function (highlight reproduction function) of conducting a reproduction operation of a highlight type. For example, this function automatically extracts scenes considered key (highlight) in a recorded one-hour program and reproduces only highlight scenes in five minutes.

Conventional techniques of such a highlight reproduction function is described in Publication of JP-A-2002-262228. This Publication describes as its problem in [0006] that “ . . . It is possible to create a more precise digest . . . Furthermore . . . it is also possible to create a digest leaving more original contents.”. [Solution] in [Abstract] describes that “When a user inputs a digest time via an input unit in the state that a setting input screen is displayed on a display unit 2, a setting condition processing unit 18 generates a creation condition by automatically setting the details of a digest. Conversely, if the details of a digest are input, the setting condition processing unit generates a creation condition by automatically setting a digest time. A schedule creation unit 16 creates a digest time schedule by designating standard reproduction, multiple speed reproduction or no reproduction in accordance with the generated digest creation condition and digest creation information acquired from stream information.”.

at page 5 of JP-A-2002-262228 Publication describes that “FIG. 2(b) shows the state that “digest: ON” is selected. In this state, a reproduction apparatus 1 conducts a reproduction operation in accordance with a time schedule generated on the basis of the digest creation condition. Also in this state, a user can instruct the reproduction apparatus 1 to conduct an operation such as play, rewinding, and fast forward, by using an operation button of an operation input unit, an external control unit or the like of the reproduction apparatus 1.”.

According to a recorder manufactured by SONY Corporation and described at pages 89 and 90 of “DVD recorder with a built-in digital Hi-vision tuner and an equipped hard disc RDZ-D97A, RDZ-D77A, RDZ-D87 Operation Manual”, when a fast forward button is depressed during a reproduction operation by a digest (highlight) reproduction function (in a highlight reproduction mode), the highlight reproduction mode is released and reproduction images can be viewed fast forward.

### SUMMARY OF THE INVENTION

Because of recent inexpensive and large capacity hard disc recording media, video recording/reproducing apparatus use hard discs for recording images. There is a video recording/reproducing apparatus equipped with a plurality of tuners to provide a multi channel simultaneous recording function. With large capacity and multi channel, a user of a video recording/reproducing apparatus can record and store a plurality of channels of desired programs at the same time and in a large capacity. There arises a problem of an insufficient view time of a user.

Usable functions include a fast forward-fast backward function of viewing reproduced images fast forward or fast backward by depressing a fast forward button or a fast backward button during normal reproduction and a time skip function of skipping a reproduction position by a predetermined time, e.g., 30-second skip. However, these functions are insufficient in terms of reduction in view time.

A video recording/reproducing apparatus has recently been equipped with a function of shortening view time. For example, this function includes a fast view function and a main content reproduction function. The fast view function is a function of shortening view time by speeding up a reproduction speed of video and audio signals. The main content reproduction function is a function of shortening view time by detecting a commercial (CM) portion through analysis of video and audio signals, skipping or fast forwarding the CM portion and reproducing only the main content.

Recent strong need is to further shorten view time by viewing only key (highlight) scenes of a sport program or the like. In order to meet this need, there arises a new function of further shortening view time (highlight reproduction function) capable of highlight type reproduction by which video and audio signals are analyzed when a program is recorded to automatically determine scenes considered key (highlight). When a highlight reproduction mode is set by operating a remote controller or the like to enable the highlight reproduction function, it is possible to reproduce and view only scenes considered key (highlight) of a program in a set reproduction time.

The scenes considered key (highlight) by the highlight reproduction function may contain scenes not considered so important by some users, because the key scenes are automatically determined by the recording/reproducing apparatus. There arises need for fast forwarding or skipping scenes not considered important by a user by using the fast forwarding function or time skip function, searching and viewing a scene considered important by the user, and then viewing only succeeding key scenes.

However, the conventional techniques described in the above-cited Publication do not consider an operation after a fast forward button or a fast backward button is depressed during a reproduction operation by the highlight reproduction function. Therefore, when the fast forward button or fast backward button is depressed in the highlight reproduction mode, the highlight reproduction mode is released to resume a normal fast forward or fast backward function, and when fast forward or fast backward is terminated, the normal reproduction mode resumes. When the next key (highlight) scene is to be reproduced and viewed, it is necessary to set again the highlight reproduction mode by depressing a button of a remote controller or the like, resulting in a problem of difficult-to-use.

Similar to the above-cited Publication, according to the conventional techniques described in the above-cited Manual, when a fast forward button is depressed in the highlight reproduction mode, the highlight reproduction mode is released so that when fast forward or fast backward is terminated, the normal reproduction mode resumes. When the next key (highlight) scene is to be reproduced and viewed, it is necessary to set again the highlight reproduction mode by depressing a button of a remote controller or the like, resulting in a problem of difficult-to-use.

An object of the present invention is to provide a video recording/reproducing apparatus equipped with a highlight reproduction function and providing an improved easy-to-use performance, wherein when the fast forward or fast backward function is released after the operation by the fast forward or fast backward function in the highlight reproduction mode, the highlight reproduction mode resumes.

The above object can be achieved by the inventions described in claims.

According to the present inventions, it is possible to provide a video recording/reproducing apparatus which is easy-to-use for users.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of a video recording/reproducing apparatus equipped with a highlight reproduction function according to the present invention.

FIG. 2 is a flow chart illustrating a fast forward operation in a highlight reproduction mode of the video recording/reproducing apparatus of the invention.

FIG. 3 is a flow chart illustrating a fast backward operation in the highlight reproduction mode of the video recording/reproducing apparatus of the invention.

FIG. 4 is a flow chart illustrating a time skip (forward) operation in the highlight reproduction mode of the video recording/reproducing apparatus of the invention.

FIG. 5 is a flow chart illustrating a time skip (backward) operation in the highlight reproduction mode of the video recording/reproducing apparatus of the invention.

FIGS. 6A to 6C are illustrative diagrams showing the operation states when a fast forward operation or a fast backward operation is conducted in the highlight reproduction mode of the video recording/reproducing apparatus of the invention.

FIGS. 7A to 7C are illustrative diagrams showing the operation states when a 30-second time skip operation is conducted in the highlight reproduction mode of the video recording/reproducing apparatus of the invention.

### DESCRIPTION OF THE EMBODIMENT

An embodiment of the present invention will now be described in the following.

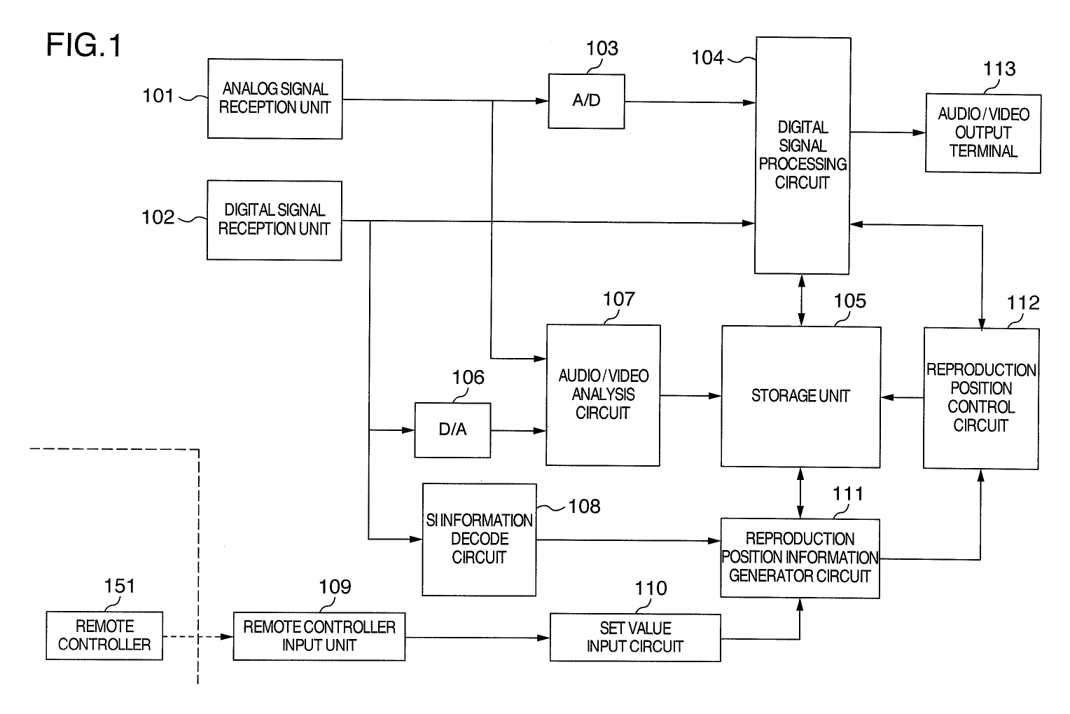

With reference to FIGS. 1 to 7, description will now be made on a video recording/reproducing apparatus according to an embodiment of the present invention.

FIG. 1 is a block diagram of a video recording/reproducing apparatus equipped with a highlight reproduction function of the present invention. With reference to FIG. 1, description will be made on the outline of the configuration and operation of the video recording/reproducing apparatus of the invention.

An analog signal reception unit 101 receives analog audio/video signals of analog broadcasts, external inputs and the like. A digital signal reception unit 102 receives digital audio/video signals of digital broadcasts. An A/D converter 103 converts an analog signal into a digital signal. A digital signal processing circuit 104 compresses and expands data in a Moving Picture Experts Group (MPEG) scheme and conducts various signal processing. A storage unit 105 records and stores audio/video data and various information in a recording medium such as a hard disc. A D/A converter 106 converts a digital signal into an analog signal. An audio/video analysis circuit 107 analyzes frequency characteristics, spatial features and temporal features of input audio/video signals. An SI information decode circuit 108 extracts SI information contained in digital broadcasts. A remote controller input unit 109 receives various input information such as a set value of reproduction time transmitted from a remote controller. A set value input circuit 110 sets the value of reproduction time in accordance with the set value of reproduction time received by the remote controller input unit 109. A reproduction position information generator circuit 111 determines a reproduction target key scene in accordance with analysis information analyzed by the audio/video analysis circuit 107 and stored in the storage unit 105 and the set value of reproduction time input from the set value input circuit 110, and generates reproduction position information of the reproduction target key scene. A reproduction position control circuit 112 controls to reproduce only the key scene in accordance with the reproduction position information designated by the reproduction position information generator circuit 111. An audio-video terminal 113 is used for outputting audio/video signals processed by the digital signal processing circuit 104 to an external television or the like. A remote controller 151 is used for inputting various information to the video recording/reproducing apparatus and controls various functions. The remote controller 151 has a disc navigation button, a highlight button, a fast forward button, a fast backward button, a 30-second skip button, a cursor button, a decision button and the like for controlling various information and inputs.

First, a recording operation will be described. Analog audio/video signals received by the analog signal reception unit 101 are A/D converted by the A/D converter 103, compressed by the MPEG scheme at the digital signal processing circuit 104, and recorded and stored in the storage unit 105. At the same time, features of the analog audio/video signals received by the analog signal reception unit 101 are analyzed by the audio/video signal analysis circuit 107, the features including a scene change and color change of video signals, a volume change and spread of audio signals, to record and store analysis information representative of features of each record target program in the storage unit 105.

Digital audio/video signals received by the digital signal reception unit 102 are compressed by the MPEG scheme at the digital signal processing circuit 104, and recorded and stored in the storage unit 105. At the same time, the digital audio/video signals received by the digital signal reception unit 102 are D/A converted by the D/A converter 106, and features of the audio/video signals are analyzed by the audio/video signal analysis circuit 107 to record and store analysis information representative of the features of each record target program in the storage unit 105.

In the video recording/reproducing apparatus, the reproduction position information generator circuit 111 determines a reproduction target key (highlight) scene in accordance with the analysis information analyzed by the audio/video analysis circuit 107 during recording and a preset value (e.g. 5 minutes) of reproduction time, generates reproduction position information, and records and stores the reproduction position information in the storage unit 105. By recording the key (highlight) scene of reproduction time (e.g., 5 minutes) which time is considered that a user viewing by the highlight reproduction function selects most often, a process of determining the key (highlight) scene at the start of the highlight reproduction function can be dispensed so that a reproduction start can be speeded up and an easy-to-use performance can be improved.

Further, the video recording/reproducing apparatus determines the key scene in accordance with reproduction time and program genre to realize more preferable and highly precise reproduction. In the case of digital broadcasts, a program contains SI information. The SI information decode circuit 108 extracts genre information. The reproduction position information generator circuit 111 determines the key scene in accordance with the analysis information analyzed by the audio/video analysis circuit 107 during recording, the preset value (e.g., 5 minutes) of reproduction time, and the genre information, generates the reproduction position information, and records and stores the reproduction position information in the storage unit 105. By adding genre information to the information which is the basis for determining the program key scene, it is possible to realize more preferable and highly precise reproduction.

Next, description will be made on the operation of a highlight reproduction mode by the highlight reproduction function.

First, a user depresses the disc navigation button of the remote controller 151, selects a reproduction target program from a displayed thumbnail list screen by using a cursor button, selects highlight reproduction, and depresses the decision button to enter the highlight reproduction mode and display a highlight reproduction screen to thereafter conduct the following operation.

In the highlight reproduction mode, the reproduction position control circuit 112 controls the reproduction position of the storage device 105 in accordance with the reproduction position information of the reproduction target key scene stored in the storage unit 105, to thereby reproduce only the reproduction target key scene. In this manner, the highlight reproduction function is realized. If there exist the preset value of reproduction time (e.g., 5 minutes) and the SI information, the reproduction position information of the key scene matching genre is recorded during recording, by using the genre information in the SI information. In this manner, a process of determining the key scene at the start of the highlight reproduction function can be dispensed so that a reproduction start can be speeded up and an easy-to-use performance can be improved.

If the reproduction time and genre are to be changed, this change can be input from the remote controller 151. In this operation, the user depresses the highlight button of the remote controller 151 in the highlight reproduction mode, and information on the genre and reproduction time input and set by the cursor key is supplied to the set value input circuit 110 which inputs setting change to the reproduction position information generator circuit 111. The reproduction position information generator circuit 111 determines the key scene to be reproduced again in accordance with the input information on the genre and reproduction time and the analysis information representative of the features of a recorded program stored in the storage unit 105, again generates the reproduction position information and sends the reproduction position information to the reproduction position control circuit 112. In accordance with this reproduction position information, the reproduction position control circuit 112 controls the reproduction position of the storage unit 105 to thereby reproduce only the reproduction target key scene.

When the user depresses the fast forward button of the remote controller 151 while the key scene is reproduced, the operation mode enters the fast forward mode so that reproduced images can be viewed fast forward. As the operation (e.g., depression of the reproduction button) of releasing fast forward is conducted thereafter, the highlight reproduction mode resumes to reproduce only the key scene and skip scenes not key. Similarly, when the fast backward button is depressed while the key scene is reproduced, the operation mode enters the fast backward mode so that reproduced images can be viewed fast backward. As a release operation is conducted, the highlight reproduction mode resumes to reproduce only the key scene. When the 30-second button which is one of time skip buttons is depressed while the key scene is reproduced, scenes of 30 seconds are skipped and thereafter the highlight reproduction mode resumes to reproduce only the key scene. As described above, images reproduced in the highlight reproduction mode are subject to a predetermined function such as fast forward, fast backward and time skip for viewing, to thereafter resume the highlight reproduction mode. An operation of entering again the highlight reproduction mode can be dispensed so that an easy-to-use performance can be improved.

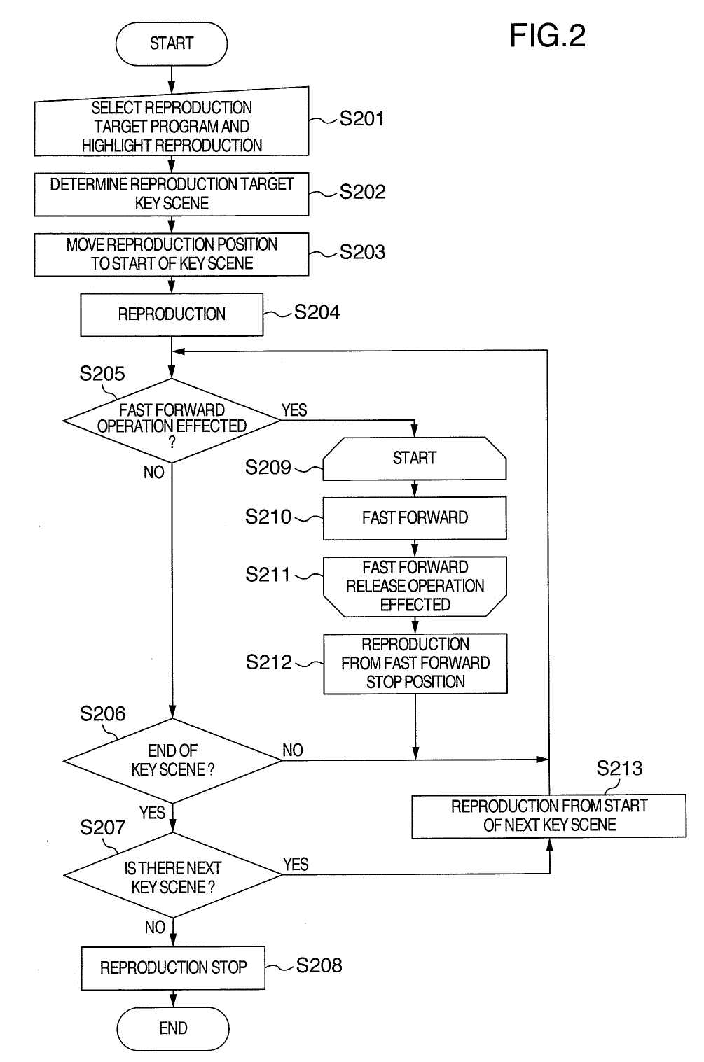

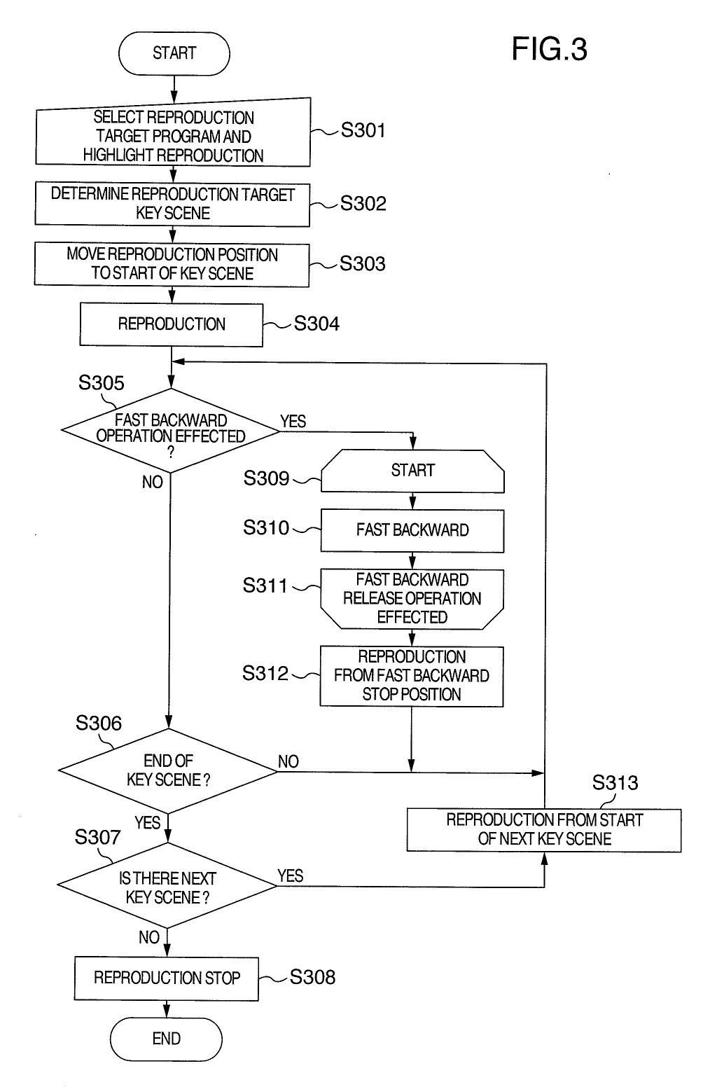

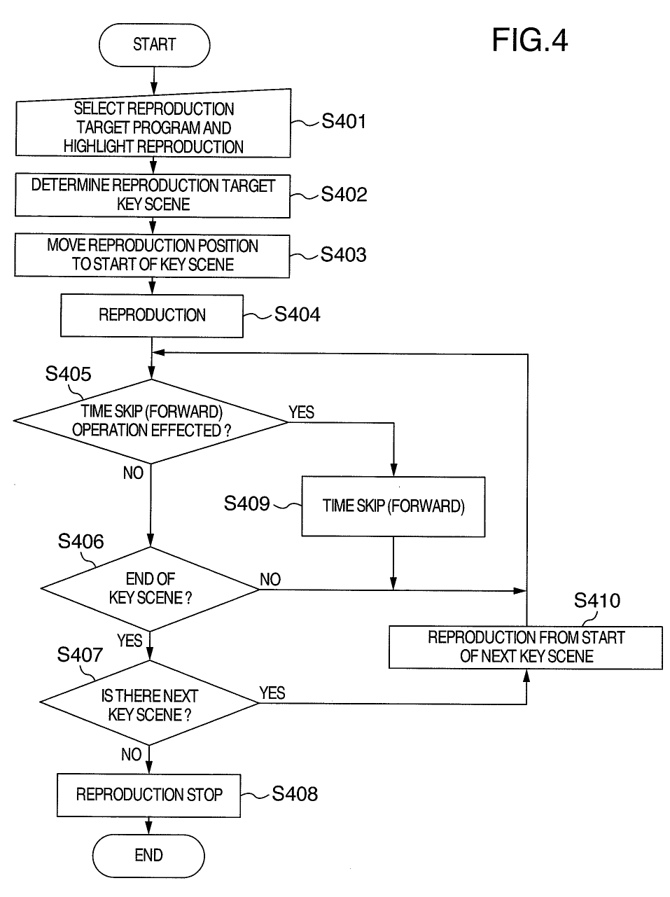

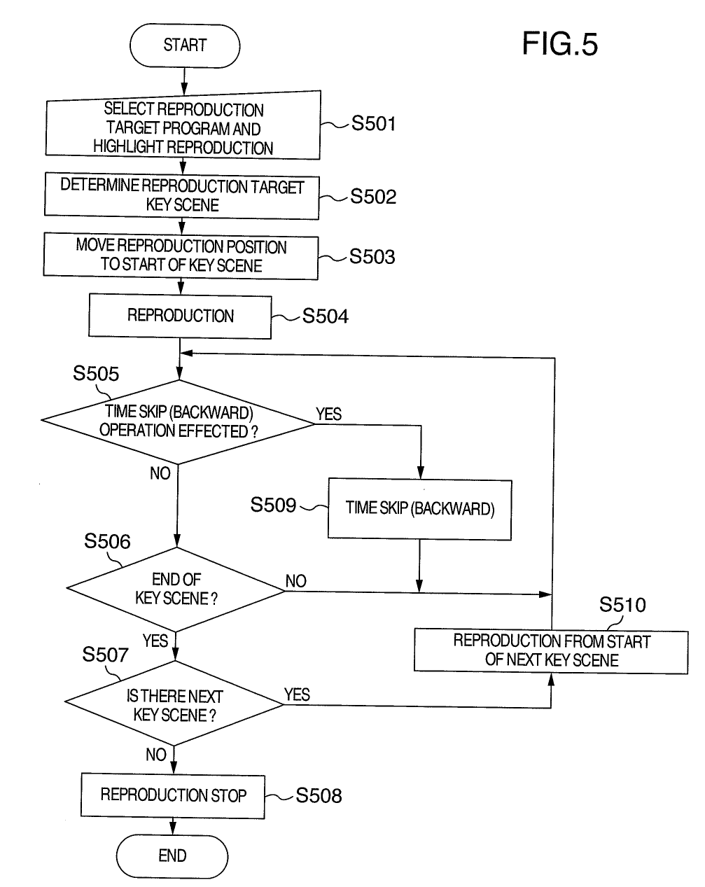

Next, with reference to FIGS. 2 to 5, description will be made on the process flow of the fast forward, fast backward and time skip operations in the highlight reproduction mode of the video recording/reproducing apparatus of the invention. FIG. 2 is a flow chart illustrating a fast forward operation in the highlight reproduction mode of the video recording/reproducing apparatus of the invention, FIG. 3 is a flow chart illustrating a fast backward operation in the highlight reproduction mode of the video recording/reproducing apparatus of the invention, FIG. 4 is a flow chart illustrating a time skip (forward) operation in the highlight reproduction mode of the video recording/reproducing apparatus of the invention, and FIG. 5 is a flow chart illustrating a time skip (backward) operation in the highlight reproduction mode of the video recording/reproducing apparatus of the invention.

With reference to the flow chart of FIG. 2, description will be made on the process flow of the fast forward operation in the highlight reproduction mode. At Step S201, the disc navigation button of the remote controller 151 is depressed, a reproduction target program is selected from the displayed thumbnail list screen, and highlight reproduction is decided to enter the highlight reproduction mode and display a highlight reproduction screen. At Step S202, the reproduction position information of a reproduction target key (highlight) scene is read from the storage unit 105. At Step S203, in accordance with the read reproduction position information, the reproduction position control circuit 112 controls the reproduction position of the storage unit 105, and at Step S204, reproduction starts from the start of the reproduction target first key scene. If a fast forward operation is not effected at Step S205, it is judged at Step S206 whether the reproduction position is the end of the key scene, and if the reproduction position is the end, it is judged at Step S207 whether there is a next reproduction target key scene. If there is the next reproduction target key scene, at Step S213 the operation skips to the start of the next key scene to start reproduction from the start and return to Step S205. These operations are repeated until the last key scene is reproduced. If it is judged at Step S207 that there is no next reproduction target scene, reproduction stops at Step S208 to terminate the highlight reproduction mode. This process flow corresponds to the ordinary highlight reproduction mode.

If the fast forward operation is effected at Step S205, a process of the fast forward function operation starts at Step S209. At Step S210, the reproduction position control circuit 112 controls to enter the fast forward mode for the storage unit 105 and output reproduced images fast forward. The fast forward operation continues until a fast forward release operation is effected at Step S211. When the fast forward release operation is effected at Step S211, a process of the fast forward function operation is terminated. At Step S212, the highlight reproduction mode resumes to start reproduction from the position when the release operation is effected, and the process returns to Step S205 to repeat until the last key scene is reproduced. This process is the feature of the present invention. After reproduced images are viewed fast forward in the highlight reproduction mode, the highlight reproduction mode resumes so that a work of setting again the highlight reproduction mode can be dispensed and an easy-to-use performance can be improved.

Next, with reference to the flow chart of FIG. 3, description will be made on the process flow of the fast backward operation in the highlight reproduction mode. The processes from Steps S301 to S308 are the same as those of the ordinary highlight reproduction mode described with reference to FIG. 2, and the description thereof is therefore omitted.

If a fast backward operation is effected at Step S305, a process of a fast backward function operation starts at Step S309. At Step S310, the reproduction position control circuit 112 controls to enter the fast backward mode for the storage unit 105 and output reproduced images fast backward. The fast backward operation continues until a fast backward release operation is effected at Step S311. When the fast forward release operation is effected at Step S311, a process of the fast backward function operation is terminated. At Step S312, the highlight reproduction mode resumes to start reproduction from the position when the release operation is effected, and the process returns to Step S305 to repeat until the last key scene is reproduced. This process is the feature of the present invention. After reproduced images are viewed fast backward in the highlight reproduction mode, the highlight reproduction mode resumes so that a work of setting again the highlight reproduction mode can be dispensed and an easy-to-use performance can be improved.

With reference to the flow chart of FIG. 4, description will be made on the process flow of the time skip (forward) operation in the highlight reproduction mode. The processes from Steps S401 to S405 and to S408 are the same as those of the ordinary highlight reproduction mode described with reference to FIG. 2, and the description thereof is therefore omitted.

If a time skip (forward) operation is effected at Step S405, scenes of a preset time (e.g., 30 seconds) are skipped forward at Step S409 to return to the process in the highlight reproduction mode, and the process returns to Step S405 to repeat reproduction until the last key scene is reproduced. This process is the feature of the present invention. Even after reproduced images of 30 seconds are skipped in the highlight reproduction mode, the highlight reproduction mode resumes so that a work of setting again the highlight reproduction mode can be dispensed and an easy-to-use performance can be improved.

With reference to the flow chart of FIG. 5, description will be made on the process flow of the time skip (backward) operation in the highlight reproduction mode. The processes at Steps S501 to S505 and to Step S508 are the same as those of the ordinary highlight reproduction mode described with reference to FIG. 2, and the description thereof is therefore omitted.

If a time skip (backward) operation is effected at Step S505, scenes of a preset time (e.g., 30 seconds) are skipped backward at Step S509 to return to the process in the highlight reproduction mode at Step S505 to repeat reproduction until the last key scene is reproduced. This process is the feature of the present invention. Even after reproduced images of 30 seconds are skipped in the highlight reproduction mode, the highlight reproduction mode resumes so that a work of setting again the highlight reproduction mode can be dispensed and an easy-to-use performance can be improved.

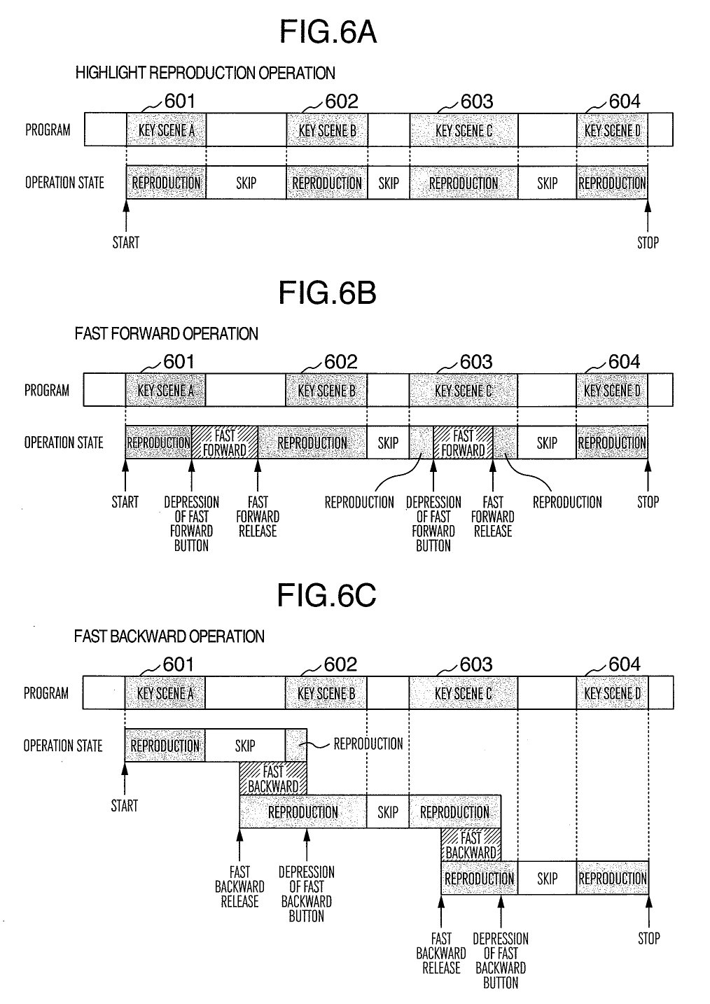

FIGS. 6A to 6C are illustrative diagrams showing the operation states when a fast forward operation or a fast backward operation is conducted in the highlight reproduction mode of the video recording/reproducing apparatus of the invention. FIG. 6A shows the operation state of the highlight reproduction, FIG. 6B shows the operation state of the fast forward operation, and FIG. 6C shows the operation state of the fast backward operation. In this example, description will be given on the assumption that one program contains four key (highlight) scenes: key scene A601, key scene B602, key scene C603 and key scene D604.

First, with reference to FIG. 6A, description will be made on the operation in the highlight reproduction mode. When the operation mode enters the highlight reproduction mode by operating the remote controller 151 in the manner described earlier, a reproduction operation starts from the start position of the key scene A601, at the end position of the key scene A601 the skip operation starts, and at the start position of the next key scene B602 the reproduction operation starts. Similarly, thereafter at the end position of the key scene B602 the skip operation starts, at the start position of the next key scene C603 the reproduction operation starts, at the end position of the key scene C603 the skip operation starts, at the start position of the next key scene D604 the reproduction operation starts, and at the end position of the last key scene D604 the reproduction operation stops to terminate the operation in the highlight reproduction mode.

Next, with reference to FIG. 6B, description will be made on the operation of the fast forward operation in the highlight reproduction mode. When the operation mode enters the highlight reproduction mode, a reproduction operation starts from the start position of the key scene A601. If the fast forward button is depressed intermediately of the reproduction operation, the fast forward operation state starts to view reproduced images fast forward. This fast forward state continues until a fast forward release operation is effected, even if the reproduction passes the end position of the key scene A601. If the fast forward release operation is effected at the position other than the key scene, the reproduction operation state starts from the position where the release operation is effected, to continue the reproduction operation to the end position of the next key scene B602. Thereafter, at the end position of the key scene B602 the skip operation starts, and at the start position of the next key scene C603 the reproduction operation starts. When the fast forward button is depressed intermediately of the key scene C603, the fast forward operation state starts to view reproduced images fast forward. When the fast forward release operation is effected intermediately of the key scene C603, the reproduction operation state starts from the position where the release operation is effected, and at the end position of the key scene C603 the skip operation starts. Thereafter, the same operation as that described with reference to FIG. 6A is conducted. As described above, even if fast forward viewing is conducted in the highlight reproduction mode, the highlight reproduction mode resumes when the fast forward release operation is effected to reproduce succeeding key scenes. Therefore, a work of setting again the highlight reproduction mode can be dispensed and an easy-to-use performance can be improved.

Next, with reference to FIG. 6C, description will be made on the operation of the fast backward operation in the highlight reproduction mode. When the operation mode enters the highlight reproduction mode, a reproduction operation starts from the start position of the key scene A601, at the end position of the key scene A601 the skip operation starts, and at the start position of the next key scene B602 the reproduction operation starts. If the fast backward button is depressed intermediately of the key scene B602, the fast backward operation state starts to view reproduced images fast backward. This fast backward state continues until a fast backward release operation is effected, even if the reproduction passes the start position of the key scene B602. If the fast backward release operation is effected at the position other than the key scene, the reproduction operation state starts from the position where the release operation is effected, to continue the reproduction operation to the end position of the key scene B602. Thereafter, at the end position of the key scene B602 the skip operation starts, and at the start position of the next key scene C603 the reproduction operation starts. When the fast backward button is depressed intermediately of the key scene C603, the fast backward operation state starts to view reproduced images fast backward. When the fast backward release operation is effected intermediately of the key scene C603, the reproduction operation state starts from the position where the release operation is effected, and at the end position of the key scene C603 the skip operation starts. Thereafter, the same operation as that described with reference to FIG. 6A is conducted. As described above, even if fast backward viewing is conducted during reproduction of the key scene, reproduction starts from the position where the fast backward release operation is effected. Therefore, a scene before the key scene determined by the video recording/reproducing apparatus can be reproduced and viewed easily, improving the easy-to-use performance.

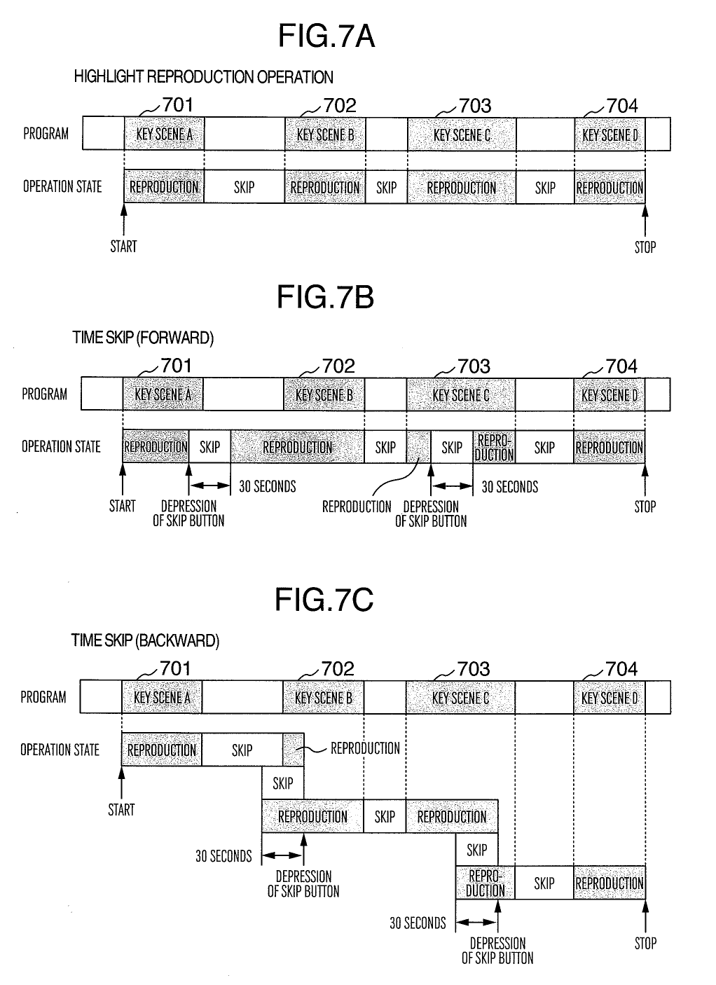

FIGS. 7A to 7C are illustrative diagrams showing the operation state when a time skip operation (e.g., 30 seconds) is conducted in the highlight reproduction mode of the video recording/reproducing apparatus of the invention. FIG. 7A shows the operation state of the highlight reproduction, FIG. 7B shows the operation state of a 30-second skip (forward) operation, and FIG. 7C shows the operation state of a 30-second skip (backward) operation. In this example, description will be given on the assumption that one program contains four key (highlight) scenes: key scene A701, key scene B702, key scene C703 and key scene D704. Since the operation of the highlight reproduction shown in FIG. 7A is the same as that described with reference to FIG. 6A, the description thereof is therefore omitted.

With reference to FIG. 7B, description will be made on the operation of the 30-second skip (forward) operation in the highlight reproduction mode. When the operation mode enters the highlight reproduction mode, a reproduction operation starts from the start position of the key scene A701. If the 30-second skip (forward) button is depressed intermediately of the reproduction operation, the skip operation state starts to skip forward by an amount corresponding to 30 seconds. If the skip operation state passes the end position of the key scene A701, the skip operation is released (automatically released and terminated) at the position other than the key scene, and the reproduction operation state starts from the released position to continue the reproduction operation to the end position of the next key scene B702. Thereafter, at the end position of the key scene B702 the skip operation starts, and at the start position of the next key scene C703 the reproduction operation starts. When the 30-second skip (forward) button is depressed intermediately of the key scene C703, the skip operation state starts to skip forward by an amount corresponding to 30 seconds. If the skip operation is released intermediately of the key scene C703, the reproduction operation state starts from the released position, and at the end position of the key scene S703 the skip operation starts. The operation to follow is the same as that described with reference to FIG. 6A. As described above, even if the 30-second skip operation is conducted in the highlight reproduction mode, the highlight reproduction mode starts from the position skipped scenes of 30 seconds to reproduce succeeding key scenes. Therefore, a work of setting again the highlight reproduction mode can be dispensed and an easy-to-use performance can be improved.

Next, with reference to FIG. 7C, description will be made on the operation of the 30-second skip (backward) operation in the highlight reproduction mode. When the operation mode enters the highlight reproduction mode, a reproduction operation starts from the start position of the key scene A701, at the end position of the key scene A701 the skip operation starts, and at the start position of the next key scene B702 the reproduction operation starts. If the 30-second skip (backward) button is depressed intermediately of the key scene B702, the skip operation state starts to skip backward the scenes of 30 seconds. If the skip operation passes the start position of the key scene B702, the skip operation is released at the position other than the key scene, and the reproduction operation state starts from the released position to continue the reproduction operation to the end position of the key scene B702. Thereafter, at the end position of the key scene B702 the skip operation starts, and at the start position of the next key scene C703 the reproduction operation starts. If the 30-second skip (backward) button is depressed intermediately of the key scene C703, the skip operation state starts to skip backward the scenes of 30 seconds. If the skip operation is released intermediately of the key scene C703, the reproduction operation state starts from the released position, and at the end position of the key scene C703 the skip operation starts. The operation to follow is the same as that described with reference to FIG. 6A. As described above, even if the 30-second skip (backward) operation is conducted in the highlight reproduction mode, the highlight reproduction mode starts from the position skipped scenes of 30 seconds. Therefore, a scene before the key scene determined by the video recording/reproducing apparatus can be reproduced and viewed easily, improving the easy-to-use performance.

In this embodiment, if the operation state of fast forward, fast backward or time skip in the highlight reproduction mode is released after the operation state passes the key scene, the reproduction starts from the released position. Instead, if the fast forward, fast backward or time skip mode is released at the position other than the key scene, the highlight reproduction may start from the start position of the next key scene by skipping to the start position. In this case, since the scene not key is skipped, time reduction is possible if the reproduction time to the next key scene is long, improving the easy-to-use performance.

Further, if the fast forward or fast backward operation state in the highlight reproduction mode passes the key scene or if the operation state reaches the next or previous key scene, the fast forward or fast backward operation may be continued if the fast forward or fast backward operation is not released in the next or previous key scene.

According to the present invention, in a video recording/reproducing apparatus equipped with a highlight reproduction function, when the fast forward, fast backward or time skip function is released after the operation by the fast forward, fast backward or time skip function in the highlight reproduction mode, the highlight reproduction mode resumes. It is therefore possible to provide a user with an improved easy-to-use performance.

It should be further understood by those skilled in the art that although the foregoing description has been made on embodiments of the invention, the invention is not limited thereto and various changes and modifications may be made without departing from the spirit of the invention and the scope of the appended claims.

1. A video recording/reproducing apparatus equipped with a highlight reproduction function of reproducing key scene in a program recorded in a storage medium, comprising:
control means for resuming an operation of a highlight reproduction function, after starting an operation of a predetermined function and operating said predetermined function during the operation of said highlight reproduction function, if said predetermined function is released or terminated.

2. The video recording/reproducing apparatus according to claim 1, wherein said predetermined function is a fast forward function, a fast backward function or a time skip function.

3. A video recording/reproducing apparatus equipped with a highlight reproduction function of reproducing a highlight scene portion in a program recorded in a storage medium, comprising:
control means for resuming an operation of a highlight reproduction function for a highlight scene to continue an operation of highlight reproduction, if a reproduction position of the program is said highlight reproduction scene portion, when an operation of a predetermined function is released or terminated after starting an operation of said predetermined function and operating said predetermined function during the operation of said highlight reproduction function.

4. A video recording/reproducing apparatus equipped with a highlight reproduction function of reproducing a highlight scene portion in a program recorded in a storage medium, comprising:
control means for resuming an operation of a highlight reproduction function for a highlight scene to continue an operation of highlight reproduction, if a reproduction position of the program is said highlight reproduction scene portion, when an operation of a predetermined function is released or terminated after starting an operation of said predetermined function and operating said predetermined function during the operation of said highlight reproduction function, and if the reproduction position of the program is not said highlight scene portion, starting reproduction from a released or terminated position, and resuming the operation of said highlight reproduction function for a highlight scene for a next highlight scene portion to continue an operation of highlight reproduction.

5. A video recording/reproducing apparatus equipped with a highlight reproduction function of reproducing a highlight scene portion in a program recorded in a storage medium, comprising:
control means for resuming an operation of a highlight reproduction function for a highlight scene to continue an operation of highlight reproduction, if a reproduction position of the program is said highlight reproduction scene portion, when an operation of a predetermined function is released or terminated after starting an operation of said predetermined function and operating said predetermined function during the operation of said highlight reproduction function, and if the reproduction position of the program is not said highlight scene portion, skipping from a released or terminated position to a next highlight scene portion, and resuming the operation of said highlight reproduction function for a highlight scene to continue an operation of highlight reproduction.

6. The video recording/reproducing apparatus according to claim 3, wherein said predetermined function is a fast forward function, a fast backward function or a time skip function, and said highlight scene is key scene of the program.

7. The video recording/reproducing apparatus according to claim 4, wherein said predetermined function is a fast forward function, a fast backward function or a time skip function, and said highlight scene is key scene of the program.

8. The video recording/reproducing apparatus according to claim 5, wherein said predetermined function is a fast forward function, a fast backward function or a time skip function, and said highlight scene is key scene of the program.
